(19) United States
(12) Patent Application Publication
(10) Pub. No.: US 2012/0247284 A1
(43) Pub. Date: Oct. 4, 2012

(54) INTERLOCK DRIVING INSTRUMENT

(75) Inventors: Nicole Murray, West Chester, PA (US); Frank Andrew Wilson, West Chester, PA (US); Kyle Henning, West Chester, PA (US); Sean Powell, West Chester, PA (US)

(73) Assignee: SYNTHES USA, LLC, West Chester, PA (US)

(21) Appl. No.: 13/073,294

(22) Filed: Mar. 28, 2011

(51) Int. Cl. B25B 15/00

(52) U.S. Cl. 81/436

(57) ABSTRACT

An interlock driving instrument is configured to be releasably lockable to a fastener, such as a bone anchor. A bone anchor can be locked to the interlock driving instrument by inserting an expandable distal end of the shaft of the interlock driving instrument into the driving opening of the bone anchor and expanding the distal end within the driving opening by translating an expansion member into the expandable distal end. Alternatively, the bone anchor can be locked to the interlock driving instrument by inserting the distal end of the shaft of the interlock driving instrument into the driving opening of the bone anchor and translating a sliding member along a sloped surface defined in a channel extending into the shaft.

### BACKGROUND

When small bone anchors, and in particular small bone screws, are inserted into or removed from a patient, there is typically a risk that the bone screws will become disengaged from the tip of the driving instrument and lost in the patient. Driving instruments to which small bone screws can be secured, or locked typically have retention sleeves or other structures mounted on the shafts of the driving instruments. These structures may cause the shaft of a driving instrument to have too large a diameter for a desired application, or may obscure a surgeon's view of the bone screw and/or the target insertion or removal location in the patient.

### SUMMARY

In an embodiment, a locking screwdriver includes a shaft extending in a longitudinal direction between a proximal end having a handle disposed thereon and an opposing expandable distal end. The shaft includes a cannulated section extending into the shaft from the distal end. The distal end of the shaft is configured to be received in a driving opening of a bone anchor. The locking screwdriver further includes an expansion member disposed in the cannulated section of the shaft. The expansion member is configured to expand the distal end of the shaft. The locking screwdriver further includes an actuator operatively coupled to the shaft and to the expansion member. The actuator is configured to longitudinally translate the expansion member within the shaft. Expansion of the distal end of the shaft by the expansion member releasably locks the distal end of the shaft in the driving opening of the bone anchor.

In an alternative embodiment, the locking screwdriver includes a shaft extending in a longitudinal direction between a proximal end having a handle disposed thereon and a distal end. A longitudinal channel extends into the shaft from the distal end. The channel includes a bottom surface that is sloped at the distal end of the shaft. The shaft includes retaining members on opposing sides of the channel. The locking screwdriver further includes a sliding member disposed in the channel and retained within the channel by the retaining members. The sliding member is translatable within the channel. The locking screwdriver further includes an actuator operatively coupled to the shaft and to a second end of the sliding member. The actuator is configured to translate the sliding member within the channel. The distal end of the shaft and a first end opposite the second end of the sliding member are configured to be concurrently received in a driving opening of a bone anchor such that when the first end of the sliding member rides along the sloped surface, the first end of the sliding member is displaced radially outward within the driving opening, releasably locking the distal end of the shaft and the first end of the sliding member within the driving opening of the bone anchor.

### BRIEF DESCRIPTION OF THE DRAWINGS

The foregoing summary, as well as the following detailed description of the preferred embodiments of the application, will be better understood when read in conjunction with the appended drawings. For the purposes of illustrating the interlock driving instrument, there are shown in the drawings preferred embodiments. It should be understood, however, that the instant application is not limited to the precise arrangements and/or instrumentalities illustrated in the drawings, in which:

FIG. 1A is a perspective exploded view of an interlock driving instrument in accordance with an embodiment;

FIG. 1B is a sectional elevation view of the interlock driving instrument illustrated in FIG. 1A in an assembled configuration;

FIG. 1C is a perspective view of the interlock driving instrument illustrated in FIG. 1A in an assembled configuration;

FIG. 2 is a sectional elevation view of selected components of the interlock driving instrument illustrated in FIG. 1A configured in accordance with an alternative embodiment;

FIG. 3A is a sectional elevation view of an actuator component of the interlock driving instrument illustrated in FIG. 1A;

FIG. 3B is a sectional elevation view of the actuator illustrated in FIG. 3A in an assembled configuration;

FIG. 4A is a sectional elevation view of the interlock driving instrument illustrated in FIG. 1A inserted into the head of a bone anchor, with the interlock driving instrument in an unlocked configuration;

FIG. 4B is a sectional elevation view of the interlock driving instrument inserted into the head of the bone anchor illustrated in FIG. 4A, with the interlock driving instrument in a locked configuration;

FIG. 5A is a perspective exploded view of the interlock driving instrument constructed in accordance with an alternative embodiment;

FIG. 5B is a sectional elevation view of the interlock driving instrument illustrated in FIG. 5A in an assembled configuration

FIG. 5C is a perspective view of the interlock driving instrument illustrated in FIG. 5A in an assembled configuration;

FIG. 6 is a sectional elevation view of a portion of the shaft of the interlock driving instrument illustrated in FIG. 5A;

FIG. 7 is a perspective view of respective portions of the shaft and the sliding member of the interlock driving instrument illustrated in FIG. 5A;

FIG. 8A is a sectional elevation view of an actuator component of the interlock driving instrument illustrated in FIG. 5A;

FIG. 8B is a front elevation view of the actuator of the interlock driving instrument illustrated in FIG. 5A;

FIG. 9A is a sectional elevation view of the interlock driving instrument illustrated in FIG. 5A inserted into the head of a bone anchor, with the interlock driving instrument in an unlocked configuration; and

FIG. 9B is a sectional elevation view of the interlock driving instrument illustrated in FIG. 9A inserted into the head of the bone anchor, with the interlock driving instrument in a locked configuration.

### DETAILED DESCRIPTION

For convenience, the same or equivalent elements in the various embodiments illustrated in the drawings have been identified with the same reference numerals. Certain terminology is used in the following description for convenience only and is not limiting. The words “right”, “left”, “top” and “bottom” designate directions in the drawings to which reference is made. The words “inward”, “inwardly”, “outward”, and “outwardly” refer to directions toward and away from the geometric center of the device and/or designated parts thereof. The terminology intended to be non-limiting includes the above-listed words, derivatives thereof and words of similar import.

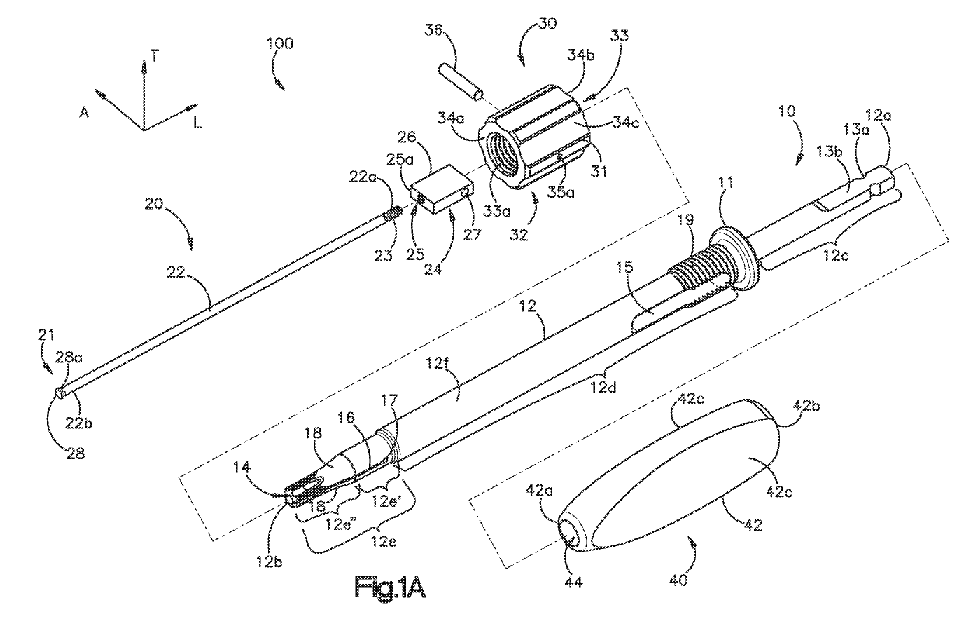

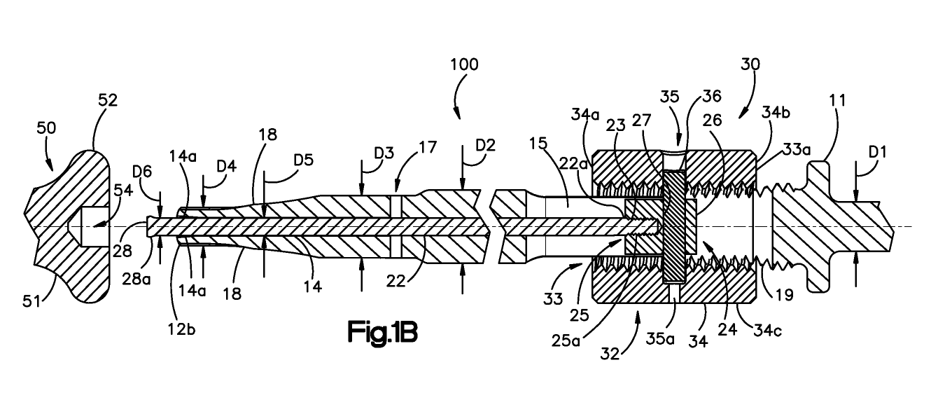

Referring initially to FIGS. 1A-C, an interlock driving instrument 100, which can also be called a locking screwdriver or an interlock screwdriver, is configured to be releasably lockable to a fastener, such as a bone anchor and in particular a bone screw. For example, when small bone anchors such as small bone screws are inserted into or removed from a patient, a secure interface between the driving instrument and the head of the bone screw is desirable, for instance to prevent loss of the bone screw inside the patient were it to become disengaged from the driving instrument. A secure, or locked interface between a bone anchor 50 and the locking screwdriver 100 can be created by inserting an expandable distal end of the locking screwdriver 100 into the driving opening 54 in the head 52 of the bone anchor 50 and expanding the distal end within the driving opening. The locking screwdriver 100 generally comprises a number of components, for instance a shaft 10, an expansion member 20, an actuator 30, and a handle 40. The various components of the locking screwdriver 100 can be made of any suitable material, for instance commercially pure titanium, titanium alloy such as TAN, stainless steel, phenolic reinforced linen, silicon, Radel®, ultra-high-molecular-weight polyethylene (UHMW), and the like.

The shaft 10 is elongate in a longitudinal direction L, and defines a shaft body 12 that extends in the longitudinal direction L between a proximal end 12a and an opposing distal end 12b, the shaft body 12 having a generally cylindrical shape. The shaft body 12 can be constructed with one or more sections of varying cross-sectional dimension, or diameter. For instance, the shaft body 12 of the illustrated embodiment is constructed with a grip section 12c having a first diameter D1, an intermediate section 12d having a second diameter D2, and an expandable section 12e that includes a first subsection 12e′ having a third diameter D3 and a second subsection 12e″ having a tapered diameter that decreases in length between the diameter D3 and a fourth diameter D4. In the illustrated embodiment, the length of the second diameter D2 is greater than the lengths of the first and third diameters D1 and D3, and the length of the fourth diameter D4 is shorter than the lengths of the first and third diameters D1-D3. It should be appreciated that the lengths of the diameters D1-D4 can be alternatively proportioned with respect to each other. It should further be appreciated that the shaft body 12 is not limited to a cylindrically shaped body, and that the shaft body 12 can be constructed with any suitable alternative shaft geometry. Moreover, it should further be appreciated that the shaft body 12 is not limited to the illustrated number of sections having varying diameters, and that the shaft body 12 can be alternatively constructed with any number of sections having uniform or varying diameters.

The grip section 12c of the shaft body 12 is configured to have a gripping structure, such as the handle 40, disposed thereon. The illustrated handle 40 includes a handle body 42 that extends longitudinally between opposing first and second ends 42a-b, respectively, and between opposing planar sides 42c, the shaft body 42 having a generally cylindrical shape. It should be appreciated that the handle 40 can be constructed with any alternative handle body geometry. A longitudinal handle bore 44 extends into the handle body 42 from the first end 42a. The handle bore 44 is configured to receive the proximal end 12a of the shaft body 12 therein. The handle 40 can be affixed to the proximal end 12a of the shaft body 12 such that it will remain coupled to the shaft body 12 during operation of the locking screwdriver 100. For instance, the handle 40 can be affixed to the proximal end 12a of the shaft body 12 by inserting the proximal end 12a of the shaft body 12 into the handle bore 44 such that an engagement structure, such as an arced ridge defined on the inner surface of the handle bore 44, is disposed into the complimentary handle retaining groove 13a defined on the proximal end 12a of the shaft body 12.

The proximal end 12a of the shaft body 12 can define a keyed section 13b, the keyed section 13b configured to be received in a complimentary keyed section of the handle bore 44. Alignment of the keyed section 13b of the shaft body 12 within the complimentary keyed section of the handle bore 44 properly orients the handle 40 on the proximal end 12a of the shaft body 12. It should be appreciated that the handle 40, the handle retaining groove 13a, and the keyed section 13b of the illustrated embodiment are not meant to be limiting. For instance, the handle 40 can be supplemented and/or replaced by an alternative gripping structure of any appropriate size and/or shape. It should further be appreciated that the handle 40 and/or any other gripping structure can be alternatively affixed to the proximal end 12a of the shaft body 12 using any appropriate engagement and/or retention structures or methods. One or more separating structures, such as the disc 11, can extend radially outward from the shaft body 12 at one or more locations, for example at the location on the shaft 10 where the grip section 12c abuts the intermediate section 12d, as illustrated.

The expandable and intermediate sections 12e and 12d, respectively, of the shaft body 12 have a continuous bore extending therethrough in the longitudinal direction L, the bore defining a cannulation, or cannulated section 14, the cannulated section 14 configured to receive the expansion member 20 therein. The length of the cannulated section 14 in the longitudinal direction L is generally defined to be slightly longer than the corresponding length of the expansion member 20, such that the expansion member 20 can be fully disposed within the cannulated section 14. The cannulated section 14 has a uniform diameter D5 throughout, the diameter D5 having a slightly longer length than the diameter D6 of the expansion member 20, such that the expansion member 20 is translatable in the longitudinal direction L within the cannulated section 14 when disposed therein.

The expandable section 12e of the shaft body 12 is configured to be expanded by longitudinal translation of the expansion member 20 into the distal end 12b of the shaft body 12. When the distal end 12b of the shaft body 12 is disposed in the driving opening 54 of a bone anchor 50, such as a bone screw 51, the expandable section 12e can be expanded to create a locked interface between the locking screwdriver 100 and the bone screw 51, as described in more detail below. It should be appreciated that while the distal end 12b of the shaft body 12 is constructed with star drive driving structures configured for insertion into a bone screw with a complimentary star drive driving opening, the distal end 12b can be alternatively constructed for use with any other type of bone anchor driving opening.

A pair of diametrically opposing slots 16 are defined in the expandable section 12e of the shaft body 12, the slots 16 extending into the distal end 12b of the shaft body 12 between distal ends 16b and opposing proximal ends 16a, and extending through the shaft body 12 from the outer surface 12f into the cannulated section 14. The slots 16 divide the expandable section 12e of the shaft body 12 into opposing resilient expansion segments 18. The expansion segments 18 are outwardly deflectable with respect to each other in a transverse direction T that is substantially perpendicular to the longitudinal direction L, for instance when the expansion member 20 is longitudinally translated into the distal end 12b of the shaft body 12, as described in more detail below. A pair of expansion bores 17 can be defined in the shaft body 12, the expansion bores 17 extending through the shaft body 12 from the outer surface 12f of the shaft body 12 into the cannulated section 14. The expansion bores 17 of the illustrated embodiment are defined at the proximal ends 16a of the slots 16, and extend through the shaft body 12 in a lateral direction A that is substantially perpendicular to both the longitudinal direction L and the transverse direction T. The diameters of the bores 17 can be sized to enhance the flexibility of the expansion segments 18, for instance by lowering the amount of force required to deflect the expansion segments 18 outwardly away from each other. It should be appreciated that the slots 16 can be defined at any location around the circumference of the shaft body 12, such that they are or are not diametrically opposed with respect to each other. It should further be appreciated that one or more, such as a plurality of longitudinal slots 16 and/or corresponding expansion bores 17 can be defined in the expandable section 12e of the shaft body 12, thereby dividing the expandable section 12e of the shaft body 12 into a corresponding plurality of expansion segments 18.

The expansion member 20 of the illustrated embodiment comprises an expansion rod 22 extending longitudinally between opposing first and second end 22a-b, respectively, the expansion rod 22 having a generally cylindrical shape. The expansion rod 22 is configured to be disposed within the cannulated section 14 of the shaft body 12. The expansion rod 22 has a uniform diameter D6 throughout, the diameter D6 having a slightly shorter length than the diameter D5 of the cannulated section 14, such that the expansion member 20 is translatable in the longitudinal direction L within the cannulated section 14 when disposed therein. The expansion rod 22 comprises an expansion tip 21 disposed at the second end 22b of the expansion rod 22, the expansion tip configured to deflect the expansion segments 18 outwardly away from each other when the expansion rod 22 is longitudinally translated into the distal end 12b of the shaft body 12. In the illustrated embodiment, the expansion tip 21 is constructed as a mandrel tip 28. The mandrel tip 28 defines a sloped surface 28a that is configured to deflect the expansion segments 18 radially outward away from each other as the expansion tip 21 is longitudinally translated into the distal end 12b of the shaft body 12, and thus into the cannulated section 14. The cannulated section 14 of the shaft body 12 can have a complimentary sloped surface 14a defined therein, for instance near the distal end 12b of the shaft body 12, the sloped surface 14a configured to engage with the sloped surface 28a of the mandrel tip 28 as the expansion tip 21 translates into the distal end 12b of the shaft body 12.

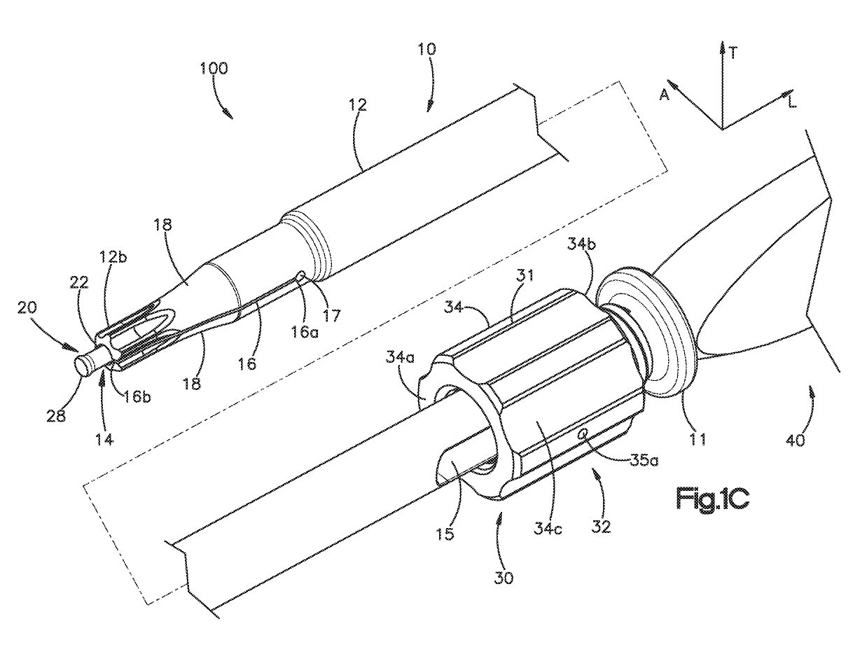

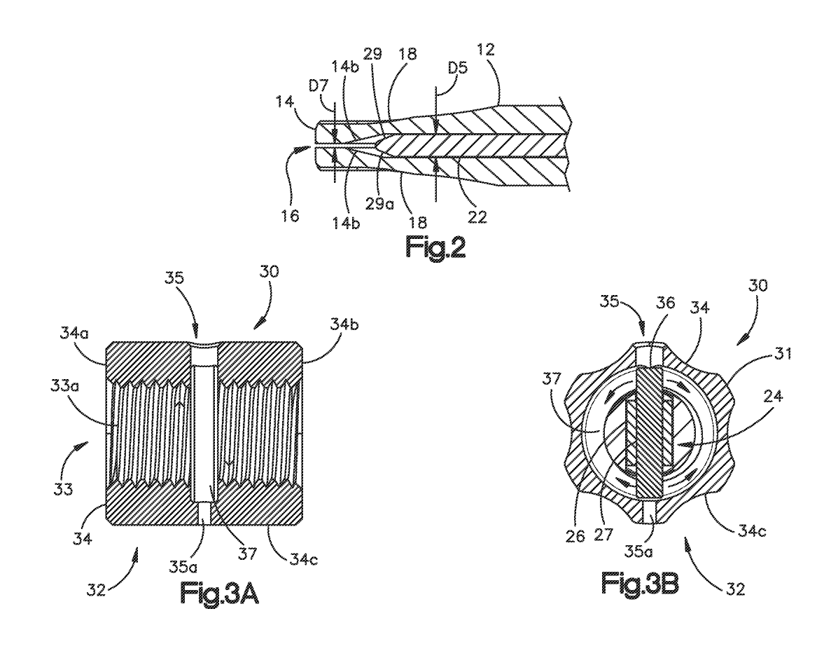

Referring now to FIG. 2, in an alternative embodiment the expansion tip 21 can be configured as a conical tip 29 having a conical surface 29a. The conical tip 29 is configured to deflect the expansion segments 18 radially outward away from each other as the expansion tip 21 is longitudinally translated into the distal end 12b of the shaft body 12 from within the cannluated section 14. As illustrated, the cannulated section 14 can be alternatively configured such that the cannulated section 14 has a narrowed section defining a sloped surface 14b near the distal end 12b of the shaft body 12. In particular, the diameter of the cannulated section 14 can be tapered in the narrowed section, for instance from the diameter D5 to a diameter D7 that has a shorter length than the diameter D5, such that the conical surface 29a of the conical tip 29 engages with the sloped surface 14b in the narrowed section of the cannulated section 14 as the expansion tip 21 translates into the distal end 12b of the shaft body 12, thereby causing the expansion segments 18 to radially deflect outwardly from each other. It should be appreciated that the expansion 21 can be integrally defined at the second end 22b of the expansion rod 22, or alternatively may be coupled to the second end 22b of the expansion rod 22, so as to be removable and/or replaceable.

Referring again to FIGS. 1A-C, the first end 22a of the expansion rod 22 is configured to be coupled to the actuator 30. In the illustrated embodiment, the expansion rod 22 is coupled to the actuator 30 via a coupling member 24, in the form of the coupling block 26. Specifically, the coupling block 26 comprises a longitudinal bore 25 defined therein, the bore 25 configured to receive the first end 22a of the expansion member 22 therein. The inner surface of the bore 25 has a plurality of threads 25a defined therein, the threads 25a configured to engage with complimentary threads 23 defined along the outer surface of the first end 22a of the expansion rod 22, such that the expansion rod 22 can be attached to the coupling block 26 by screwing the first end 22a into the bore 25. The coupling block 26 further comprises a pin bore 27 extending therethrough along the lateral direction A, the pin bore 27 configured to receive a pin 36 that couples the coupling block 26 to the actuator 30. The shaft body 12 further comprises a block slot 15 defined therethrough, the block slot 15 extending through the shaft body 12 along the lateral direction A and sized to receive the coupling block 26 therein such that the coupling block 26 is translatable in the longitudinal direction L within the block slot 15. The block slot 15 is defined with a longitudinal length sufficient to allow the coupling block 26, and thus the expansion rod 22, to longitudinally translate within the block slot 15 as the locking screwdriver 100 is operated between unlocked and locked configurations, as described in more detail below. It should be appreciated that while the illustrated coupling block 26 has a generally rectangular shape, the coupling block 26 can be alternatively configured with any appropriate shape. It should further be appreciated that the locking screwdriver 100 can be alternatively constructed with the coupling block 26 omitted, such that the expansion member 20, and in particular the expansion rod 22, can be directly coupled to the actuator 30.

Referring now to FIGS. 1A-C and 3A-B, the expansion member 20 is operatively coupled to the actuator 30, and the actuator 30 is operatively coupled to the shaft 10, such that when the actuator 30 is operated, the expansion member 20 is longitudinally translated within the cannulated section 14 of the shaft body 12. For example, in the illustrated embodiment, the actuator 30 is provided as a knob 32. The knob 32 comprises a knob body 34 that extends in the longitudinal direction L between opposing first and second ends 34a-b, respectively, the knob body 34 having a generally cylindrical shape. The knob body 34 defines a circumferential outer surface 34c. The outer surface 34c can have gripping structures, such as the ridges 31, defined thereon, the ridges 31 extending radially outward from the outer surface 34c.

The knob body 34 comprises a shaft bore 33 defined therethrough, the shaft bore 33 extending from the first end 34a through the second end 34b of the knob body 34 along the longitudinal direction L. The inner surface of the shaft bore 33 has a plurality of threads 33a defined therein, the threads 33a configured to rotatably engage with complimentary threads 19 defined on the outer surface 12f of the shaft body 12. The diameter of the shaft bore 33 has a length that is slightly longer than the length of the diameter D2 of the intermediate section 12d of the shaft body 12, such that the actuator 30 can be disposed on the shaft body 12 and the threads 33a of the actuator engaged with the threads 19 of the shaft body 12. It should be appreciated that the illustrated location of the threads 19 on the shaft body 12, and thus the location where the actuator 30 couples to the shaft 10, is not meant to be limiting, and that the interface between the shaft 10 and the actuator 30 can be located anywhere along the shaft 10 as appropriate. It should further be appreciated that the actuator 30 should not be limited to the knob 32, and that alternatively, any actuator that translates operation of the actuator into longitudinal translation of the expansion member 20 can be provided.

The knob body 34 further comprises a pin bore 35 defined therethrough, the pin bore 35 extending through diametrically opposed sides of the body 34 along the lateral direction A. The pin bore 35 is configured to receive the pin 36, the pin 36 configured to couple the expansion member 20, and in particular the coupling block 26, to the actuator 30. As depicted in FIGS. 3A-B, the knob body 34 further comprises an annular groove 37 that extends radially outward into the shaft bore 33, the annular groove 37 configured to allow rotation of the knob body 34 about the pin 36 during rotational operation of the knob 32. The pin bore 35 defines a narrowed section 35a on one of the opposing sides of the body 34, the narrowed section 35a extending from the bottom surface of the annular groove 37 through the outer surface 34c of the body, the narrowed section 35a configured with a diameter that is shorter in length than the diameter of the pin 36, such that when the pin 36 is inserted into the pin bore 35, the pin 36 abuts the narrowed section 35a such that the pin 36 is seated in the annular groove 37, and thus remains stationary with respect to the knob 32 during rotational operation of the knob 32. Specifically, when the coupling block 26 is disposed in the block slot 15 of the shaft body 12 and is operably coupled to the knob 32 by fully inserting the pin 36 into the pin bores 27 and 35, the pin 36 and the coupling block 26 can remain stationary with respect to the knob 32 while the knob 32 is rotated with respect to the shaft body 12.

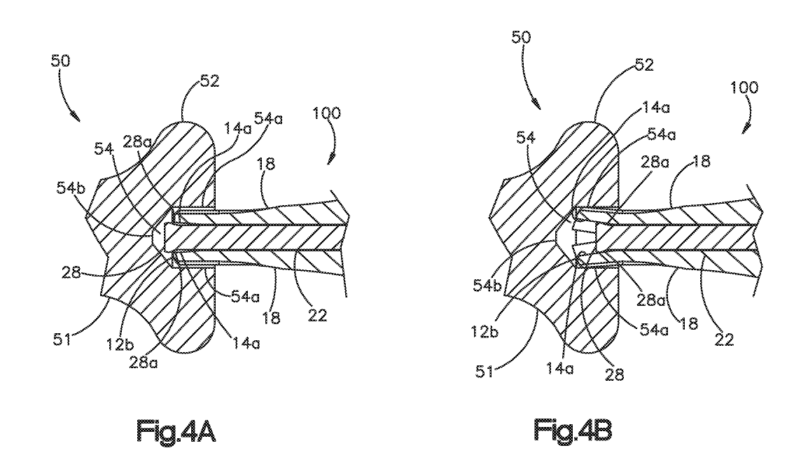

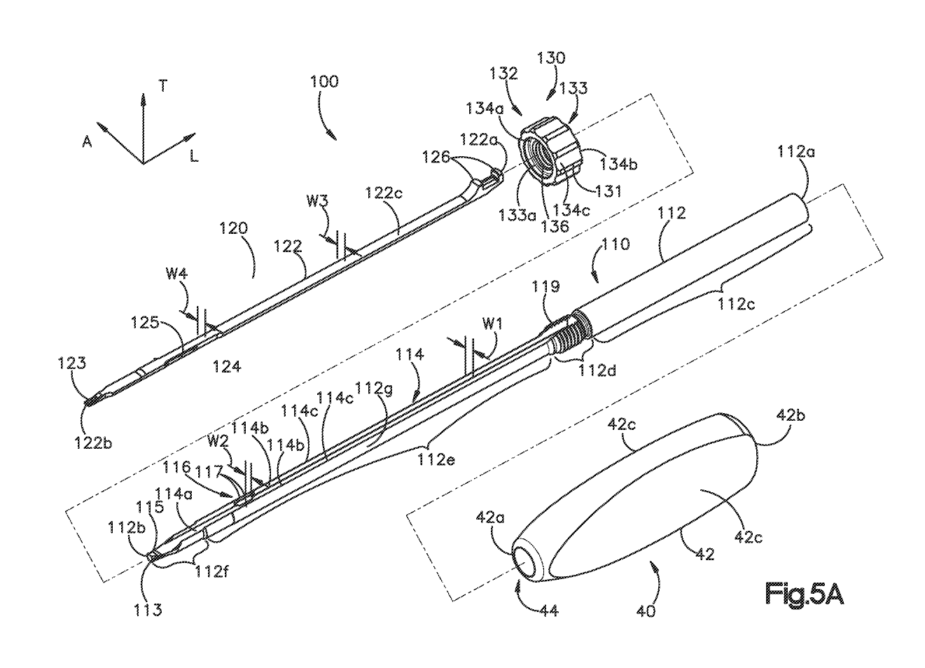

Referring now to FIGS. 1A-C and 4A-B, in operation, a bone anchor 50, such as the bone screw 51, can be locked onto the locking screwdriver 100 for insertion and/or removal of the bone screw 51, for example into underlying bone of a patient. In particular, the distal end 12b of the shaft body 12 can be disposed into the driving opening 54 in the head 52 of the bone screw 51 and expanded, such that a secured, or locked, interface between the distal end 12b of the shaft body 12 and the driving opening 54 of the bone screw 51 is created. As necessary, the locking screw driver 100 can be operated to the non-expanded, or unlocked, configuration depicted in FIG. 4A. In the unlocked configuration, the mandrel tip 28, and in particular the sloped surface 28a, of the expansion rod 22 is located beyond the distal end 12b of the shaft body 12 such that the expansion segments 18 of the expansion section 12e of the shaft body 12 are in a relaxed, non-expanded position. The locking screwdriver 100 can be operated to the relaxed configuration by rotating the knob 32 of the actuator 30 in a direction about the shaft 10 that causes the threads 33a of the knob 32 to engage the complimentary threads 19 of the shaft 10 such that the actuator 30 longitudinally translates within the cannulated section 14 of the shaft 10 in a direction towards the distal end 12b of the shaft body 12. As the actuator 30 translates, the expansion member 20 (including the coupling block 26 and the expansion rod 22) is translated toward the distal end 12b of the shaft body 12 concurrently with the actuator 30. In this way, the mandrel tip 28 of the expansion rod 22 can be translated to a longitudinal location beyond the distal end 12b of the shaft body 12, as illustrated in FIG. 4A.

With the locking screwdriver 100 in the unlocked configuration, the distal end 12b of the shaft body 12 is inserted into the driving opening 54 in the head 52 of the bone screw 51. With the distal end 12b of the shaft body 12 inserted into the driving opening 54 of the bone screw 51, the locking screw driver 100 can be operated from the locked configuration to an expanded, or locked configuration within the driving opening 54 of the bone screw 51. The locking screwdriver 100 can be operated to the locked configuration by rotating the knob 32 of the actuator 30 about the shaft 10 in a direction that causes the threads 33a of the knob 32 to engage the complimentary threads 19 of the shaft 10 such that the actuator 30 longitudinally translates within the cannulated section 14 of the shaft 10 in a direction away from the distal end 12b of the shaft body 12 (i.e., the knob 32 is rotated in the direction opposite from the direction of rotation utilized to operate the locking screw driver 100 into the unlocked configuration). As the actuator 30 translates, the expansion member 20 (including the coupling block 26 and the expansion rod 22) is translated away from the distal end 12b of the shaft body 12 concurrently with the actuator 30. In this way, the mandrel tip 28 of the expansion rod 22 is translated into the distal end 12b of the shaft body 12, as illustrated in FIG. 4B.

As the mandrel tip 28 of the expansion rod 22 translates into the distal end 12b of the shaft body 12, the sloped surface 28a of the mandrel tip 28 rides along the complimentary sloped surfaces 14a of the cannulated section 14 of the shaft body 12, thereby causing the expansion segments 18 to radially deflect outwardly with respect to each other. As the mandrel tip 28 of the expansion rod 22 translates further into the distal end 12b of the shaft body 12, the outer surfaces 12f of the expansion segments 18 engage with the inner walls 54a of the driving opening 54 of the bone screw 51, imparting outwardly directed forces from the expansion segments 18 of the shaft body 12 to the driving inner walls 54a of the driving opening 54, and imparting inwardly directed forces from the inner walls 54a of the driving opening 54 to the expansion segments 18 of the shaft body 12 such that the driving opening 54 becomes locked in place on the expansion segments 18. The bone screw 51 can then be driven into or backed out of the underlying structure. When the bone screw 51 has been fully driven or removed, the actuator 30 can be operated to operate the locking screwdriver 100 to the unlocked configuration, wherein the distal end 12b of the shaft body 12 can be removed from the driving opening 54 of the bone screw 51. It should be appreciated that when operating the locking screwdriver 100 to the unlocked configuration, the actuator 30 can be advanced such that the expansion tip 21 of the expansion rod 22 abuts the bottom 54b of the driving opening 54 of the bone screw 51, thereby imparting a force from the expansion rod 22 to the head 52 of the bone screw 51, the force causing the bone screw 51 to be ejected from the distal end 12b of the shaft body 12.

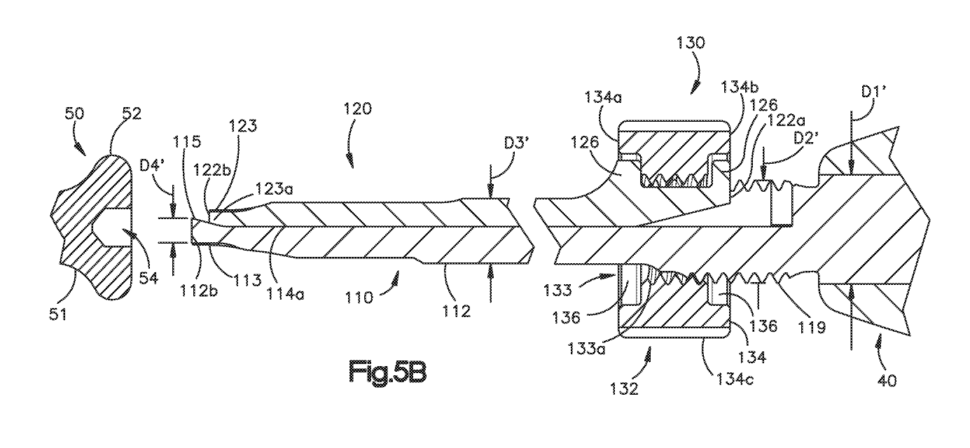

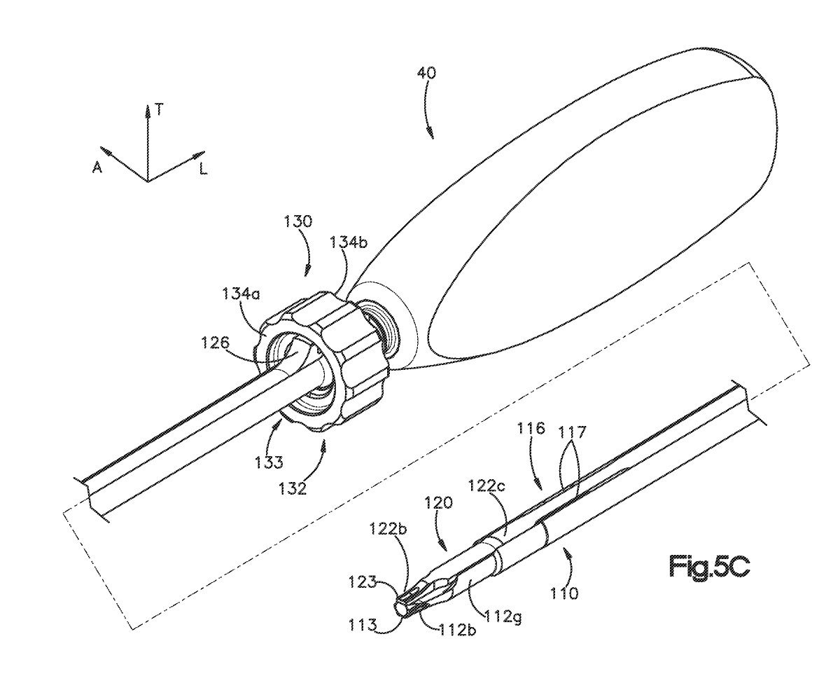

Referring now to FIGS. 5A-C, the locking screwdriver 100 is illustrated in accordance with an alternative embodiment. A secured, or locked, interface between a bone anchor 50 and the illustrated embodiment of the locking screwdriver 100 can be created by inserting the distal end of the locking screwdriver 100 into the driving opening 54 of the bone anchor 50 and operating the locking screwdriver 100 to longitudinally advance a sliding member into the distal end of the locking screwdriver 100, as described in more detail below. The illustrated embodiment of the locking screwdriver 100 generally comprises a number of components, such as a shaft 110, a sliding member 120, an actuator 130, and a handle 40.

The shaft 110 is elongate in the longitudinal direction L, and defines a shaft body 112 that extends in the longitudinal direction L between a proximal end 112a and an opposing distal end 112b, the shaft body 112 having generally cylindrically shape. The shaft body 112 can be constructed with one or more sections of varying cross-sectional dimension, or diameter. For instance, the shaft body 112 of the illustrated embodiment is constructed with a grip section 112c having a first diameter D1′, an actuator section 112d having a second diameter D2′, an intermediate section 112e having a third diameter D3′, and a tip section 112f having a tapered diameter that decreases in length between the diameter D3′ and a fourth diameter D4′. In the illustrated embodiment, the length of the first diameter D1′ is greater than the length of the second diameter D2′, which is greater than the length of the third diameter D3′, which is greater than the length of the fourth diameter D4′. It should be appreciated that the lengths of the diameters D1′-D4′ can be alternatively proportioned with respect to each other. It should further be appreciated that the shaft body 112 is not limited to a cylindrically shaped body, and that the shaft body 112 can be constructed with any suitable alternative shaft geometry. Moreover, it should further be appreciated that the shaft body 112 is not limited to the illustrated number of sections having varying diameters, and that the shaft body 112 can be alternatively constructed with any number of sections having uniform or varying diameters.

The grip section 112c of the shaft body 112 is configured to have a gripping structure, such as the handle 40, disposed thereon. It should be appreciated that the handle 40 and/or any other gripping structure can be affixed to the proximal end 112a of the shaft body 112 using any appropriate engagement and/or retention structures or methods. The distal end 112b of the shaft body 112 can be constructed as a driving tip 113. The driving tip 113 and the driving tip 123 of the sliding member 120 can be respective driving structures defined thereon, the driving structures complimentary to the type of bone screw the locking screwdriver 100 is to be used with. For example, as depicted in FIG. 5C, the driving tips 113 and 123 have star drive structures defined thereon for insertion into a bone screw with a complimentary star drive driving opening. It should be appreciated that the driving tips 113 and/or 123 can be alternatively constructed with any other driving structures for use with respective alternative types of bone anchor driving openings.

The actuator, intermediate, and tip sections 112d, 112e, and 122f, respectively, of the shaft body 112 have a continuous longitudinal channel 114 defined therein, the channel 114 configured to receive the expansion member 120. The longitudinal length of the channel 114 is generally defined to be slightly longer than the longitudinal length of the sliding member 120, such that the sliding member 120 can be fully disposed within the channel 114. The channel 114 is configured as an open channel of rectangular cross section that has a bottom surface 114a and opposing side surfaces 114b that extend perpendicularly in the transverse direction T between the bottom surface 114a and respective upper edges 114c that are defined along the intersection of the side surfaces 114b with the outer surface 112g of the shaft body 112. The channel has a width W1 in the lateral direction A that is shorter than the length of the diameter D3′. The cross-sectional geometry of the channel 114 is configured such that the sliding member 120 is translatable in the longitudinal direction L within the channel 114 when disposed therein. It should be appreciated that the channel 114 is defined with a generally rectangular cross section so as to conform with the generally rectangular cross section of the sliding member 120, and that other appropriate channel geometries can alternatively be defined, for example to conform with alternatively constructed sliding members 120. The bottom surface 114a of the channel 114 has a sloped surface 115 defined between the distal end 112b of the shaft body 112 and a transition of the sloped surface 115 into the bottom surface 114a, the sloped surface 115 configured such that the sliding member 120 rides along the sloped surface 115 when the sliding member 120 is longitudinally translated into the distal end 112b of the shaft body 112. It should be appreciated that the sloped surface 115 is not limited to the straight surface of the illustrated embodiment. For instance, the sloped surface 115 can be curved between the distal end 112b and the transition into the bottom surface 114a, or can be alternatively defined using any other surface geometry.

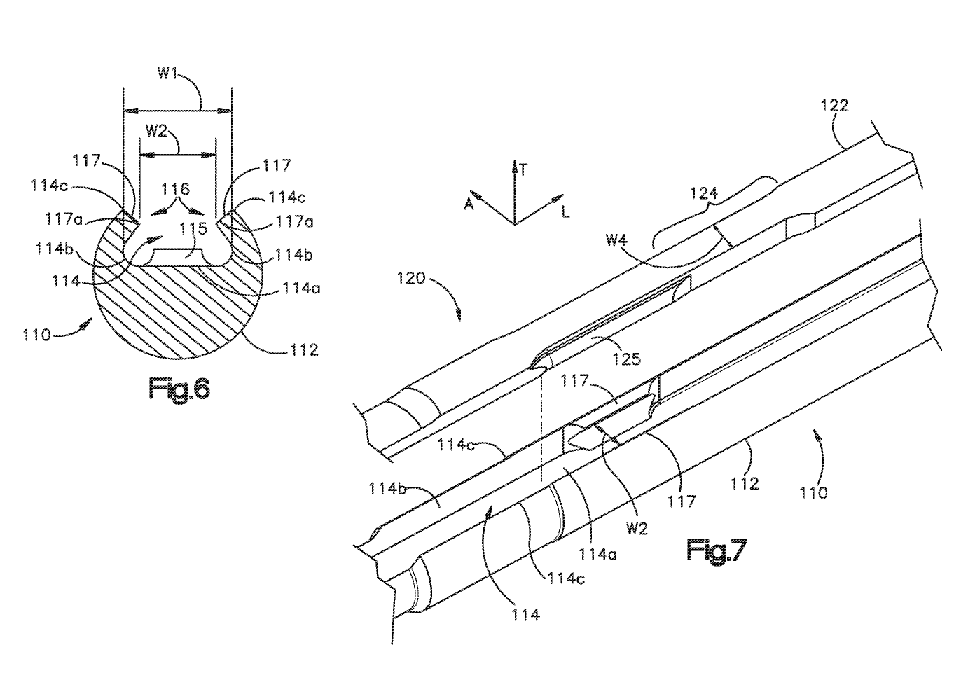

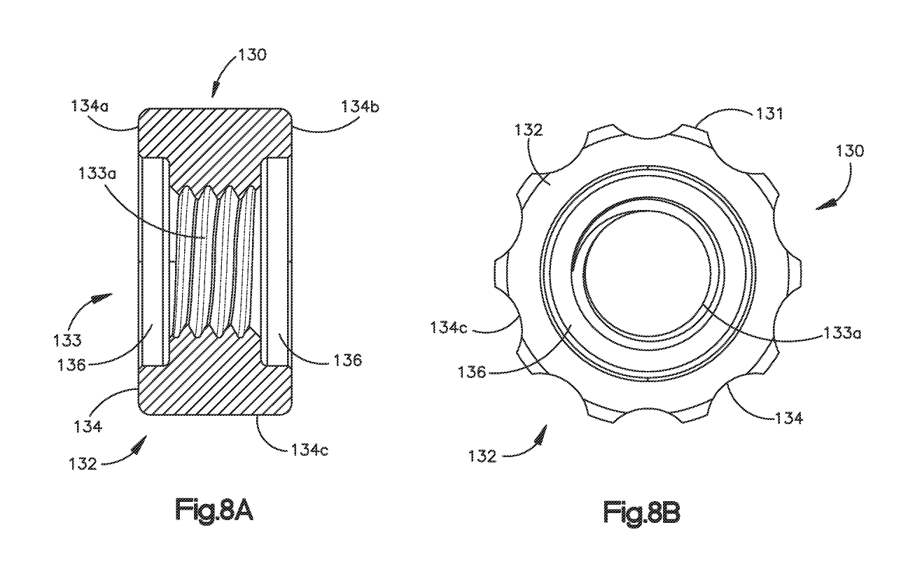

The shaft body 112 further comprises retaining members 116, the retaining members 116 configured to retain the sliding member 120 within the channel 114. As depicted in FIG. 6, the retaining members 116 of the illustrated embodiment are defined as a pair of opposing arc shaped, or arced, protrusions 117 that extend inwardly from the side surfaces 114b on opposing sides of the channel 114. The protrusions 117 extend inwardly to ends 117a. The ends 117a of the protrusions 117 are separated by a gap that has a width W2 that is shorter in length than the width W1 of the channel 114. It should be appreciated that the retaining members 116 are not limited to the protrusions 117, and that one or more retaining members 116 can be alternatively defined utilizing any appropriate structure and/or geometry.

Referring again to FIGS. 5A-C, the sliding member 120 of the illustrated embodiment includes a sliding member body, or body 122 that extends longitudinally between opposing first and second ends 122a-b, respectively, the body 122 having a generally rectangular cross section. The body 122 defines a width W3 in the lateral direction A that is slightly shorter in length than the width W1 of the channel 114 of the shaft body 112, such that when the sliding member 120 is disposed in the channel 114, the sliding member 120 is slidable, or translatable, in the longitudinal direction L within the channel 114. The cross-sectional geometry of the upper surface 122c of the body 122 can be defined to match the cross-sectional geometry of the outer surface 112g of the shaft body 112 when the sliding member 120 is disposed in the channel 114. For instance, in the illustrated embodiment, the upper surface 122c of the body 122 is curved to match the curvature of the outer surface 122c of the body 122.

The first end 122a of the sliding member 120 is configured to be coupled to the actuator 130. Specifically, the body 122 comprises one or more coupling members, such as the tabs 126 defined on the first end 122a of the body 122. The tabs 126 extend upwardly in the transverse direction T from the upper surface 122c of the body 122, the tabs 126 configured to be received in respective complimentary annular grooves 136 defined in the actuator 130, as described in more detail below. The body 122 further comprises a driving tip 123 defined at the second end 122b of the body 122. As described above, the driving tip 123 can be constructed with driving structures defined thereon, such as the illustrated star drive driving structures, that are complimentary to the type of bone screw the locking screwdriver 100 is to be used with. The driving tip 123 is configured to ride along the sloped surface 115 of the channel 114 such that the driving tip 123 is deflected radially upward within the channel 114 when the second end 122b of the sliding member 120 is longitudinally translated into the distal end 112b of the shaft body 112, as described in more detail below. The driving tip 123 can have a complimentary sloped surface 123a defined in its bottom surface, the sloped surface 123a configured to engage with the sloped surface 115 of the channel 114. It should be appreciated that the sloped surface 123a is not limited to a straight surface. For instance the sloped surface 123a can be curved, or can be defined using any other surface geometry.

Referring now to FIG. 7, the body 122 further comprises a narrowed section 124, the narrowed section 124 having a width W4 in the lateral direction A that is slightly shorter than the width W2 of the gap between the protrusions 117, such that when the sliding member 120 is disposed into the channel 114, the narrowed section 124 of the body 122 can fit through the gap between the protrusions 117. The body 122 further comprises a pair of longitudinal wings 125 defined in the body 122, the wings 125 extending in the longitudinal direction L between the narrowed section 124 and the distal end 122b of the body 122. The wings 125 are configured to be nested in sliding engagement within the protrusions 117. During operation of the locking screwdriver 100 between unlocked and locked configurations, described in more detail below, the outer surfaces of the wings 125 engage with the inner surfaces of the protrusions 117, thereby retaining the sliding member 120 within the channel 114. The wings 125 are defined with longitudinal lengths sufficient to maintain the nested engagement of the wings 125 within the protrusions 117 as the locking screwdriver 100 is operated between unlocked and locked configurations.

Referring now to FIGS. 5A-C and 8A-B, the sliding member 120 is operatively coupled to the actuator 130, and the actuator 130 is operatively coupled to the shaft 110, such that when the actuator 130 is operated, the sliding member 120 is longitudinally translated within the channel 114 of the shaft body 112. For example, in the illustrated embodiment the actuator 130 is provided as a knob 132. The knob 132 comprises a knob body 134 that extends in the longitudinal direction L between opposing first and second ends 134a-b, respectively, the knob body 134 having a generally cylindrical shape. The knob body 134 defines a circumferential outer surface 134c. The outer surface 134c can have gripping structures, such as the ridges 131, defined thereon, the ridges 131 extending radially outward from the outer surface 134c.

The knob body 134 comprises a shaft bore 133 defined therethrough, the shaft bore 133 extending from the first end 134a through the second end 134b of the body along the longitudinal direction L. The inner surface of the bore 133 has a plurality of threads 133a defined therein, the threads 133a configured to rotatably engage with a complimentary threads 119 defined on the outer surface 112g of the shaft body 112. The diameter of the bore 133 has a length that is slightly longer than the length of the diameter D2′ of the actuator section 112d of the shaft body 112, such that the actuator 130 can be disposed on the shaft body 112 and the threads 133a of the actuator engaged with the threads 119 of the shaft body 112. It should be appreciated that the illustrated location of the threads 119 on the shaft body 112, and thus the location where the actuator 130 couples to the shaft 110, is not meant to be limiting, and that the interface between the shaft 110 and the actuator 130 can be located anywhere along the length of the shaft 110 as appropriate. It should further be appreciated that the actuator 130 should not be limited to the knob 132, and that alternatively, any actuator that translates operation of the actuator into longitudinal translation of the sliding member 120 can be provided.

The knob body 134 further comprises a coupling interface, the coupling interface configured to couple the sliding member 120 to the actuator 130 when complimentary coupling members, such as the tabs 126, are received in the coupling interface. In the illustrated embodiment, the coupling interface comprises a pair of annular grooves 136 that extend inwardly into the knob body 134 from the first and second ends 134a-b, respectively. The annular grooves 136 are configured to allow rotation of the knob body 134 about the tabs 126 during rotational operation of the knob 132. Specifically, when the tabs 126 are disposed in the respective annular grooves 136, the sliding member 120 can remain stationary with respect to the knob 132 while the knob 132 is rotated with respect to the shaft body 112.

Referring now to FIGS. 5A-C and 9A-B, in operation, a bone anchor 50, such as the bone screw 51, can be locked onto the locking screwdriver 100 for insertion and/or removal of the bone screw 51, for example into underlying bone of a patient. The bone screw 51 can be locked onto the locking screwdriver 100 by inserting the driving tips 113 and 123 into the driving opening 54 of the bone screw 51 and operating the locking screwdriver 100 into the locked configuration.

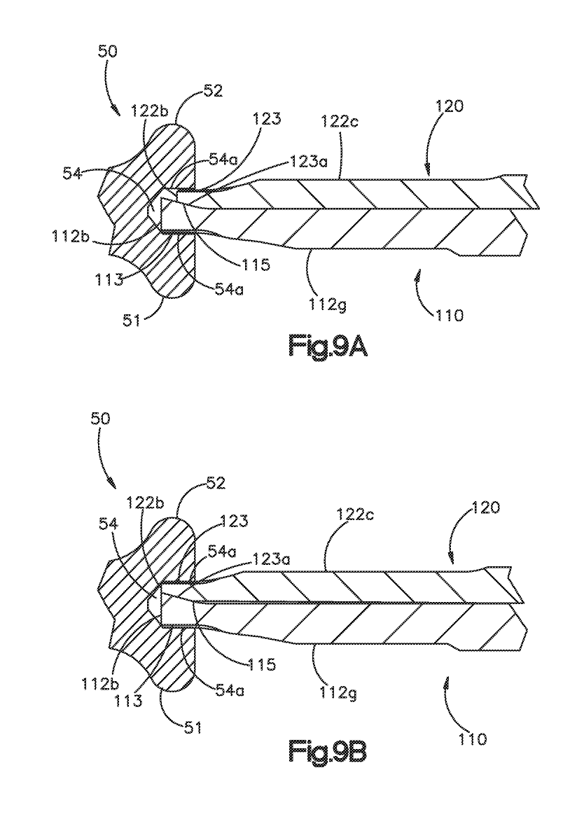

It is preferable to insert the driving tips 113 and 123 into the driving opening 54 of the bone screw 51 with the locking screwdriver 100 in the fully unlocked configuration. In the fully unlocked configuration, the sliding member 120 is longitudinally translated within the channel 114 such that the sliding member 120 lies flat against the bottom surface 114a of the channel 114 and the sloped surface 123a of the driving tip 123 lies at the bottom of the sloped surface 115 where the sloped surface 115 transitions to the bottom surface 114a of the channel 114, as illustrated in FIG. 9A. It should be appreciated that the driving tips 113 and 123 may still be insertable into the driving opening 54 of the bone screw 51 when the locking screw driver 100 is in a partially unlocked configuration, for instance when the sloped surface 123a of the driving tip 123 has been longitudinally translated along the sloped surface 115 a short distance.

With the locking screwdriver 100 in the partially or fully unlocked configuration, the driving tips 113 and 123 are inserted into the driving opening 54 of the bone screw 51. With the driving tips 113 and 123 inserted into the driving opening 54, the locking screw driver 100 is then operated to the locked configuration. The locking screwdriver 100 can be operated to the locked configuration by rotating the knob 132 of the actuator 130 about the shaft 110 in a direction that causes the threads 133a of the knob 132 to engage the complimentary threads 119 of the shaft 110 such that the actuator 130 longitudinally translates along the shaft 110 in a direction towards the distal end 112b of the shaft body 112. As the actuator 130 translates, one or more of the annular grooves 136 engage with respective tabs 126 of the sliding member 120, causing the sliding member 120 to concurrently translate with the actuator 130.

As the sliding member 120 translates towards the distal end 112b of the shaft body 112, the driving tip 123, and in particular the sloped surface 123a, rides along the sloped surface 115. As it rides along the sloped surface 123a, the driving tip is 123 is deflected radially upward, causing the upper surface 122c of the driving tip 123 and the outer surface 112g of the driving tip 113 to engage with the respective inner walls 54a of the driving opening 54 of the bone screw 51, imparting outwardly directed forces from the driving tips 113 and 123 to the inner walls 54a of the driving opening 54, and imparting inwardly directed forces from the inner walls 54a of the driving opening 54 to the driving tips 113 and 123 such that the driving opening 54 becomes locked in place on the driving tips 113 and 123. The bone screw 51 can then be driven into or backed out of the underlying structure. When the bone screw 51 has been fully driven or removed, the actuator 130 can be operated to operate the locking screwdriver 100 to the unlocked configuration, wherein the driving tips 113 and 123 can be removed from the driving opening 54 of the bone screw 51.

Although the components of the interlock driving instrument 100 have been described herein with reference to preferred embodiments and/or preferred methods, it should be understood that the words which have been used herein are words of description and illustration rather than words of limitation, and that the present invention is therefore not intended to be limited to the disclosed embodiments. Furthermore, the structure and features of each of the embodiments described above can be applied to the other embodiments described herein, unless otherwise indicated. Additionally, it should be appreciated that although interlock driving instrument 100 has been described herein with reference to particular structure, methods, and/or embodiments, the scope of the instant disclosure is not intended to be limited to those particulars, but rather is meant to extend to all structures, methods, and/or uses of the interlock driving instrument 100. Those skilled in the relevant art, having the benefit of the teachings of this specification, may effect numerous modifications to the interlock driving instrument 100 as described herein, and changes may be made without departing from the scope and spirit of the instant disclosure, for instance as recited in the appended claims.

What is claimed:

1. A locking screwdriver comprising:
a shaft extending in a longitudinal direction between a proximal end having a handle disposed thereon and an opposing expandable distal end, the shaft defining a cannulated section extending into the shaft from the distal end, the distal end of the shaft configured to be received in a driving opening of a bone anchor;
an expansion member disposed in the cannulated section of the shaft, the expansion member configured to expand the distal end of the shaft; and
an actuator operatively coupled to the shaft and to the expansion member, the actuator configured to longitudinally translate the expansion member within the shaft,
wherein expansion of the distal end of the shaft by the expansion member releasably locks the distal end of the shaft in the driving opening of the bone anchor.

2. The locking screwdriver as recited in claim 1, wherein the distal end comprises a plurality of resilient expansion segments, the expansion segments configured to be radially deflectable.

3. The locking screwdriver as recited in claim 2, wherein the plurality of expansion segments are defined by at least one slot extending longitudinally into the shaft from the distal end towards the proximal end.

4. The locking screwdriver as recited in claim 2, wherein the expansion member comprises an expansion rod extending between a first end coupled to the actuator and a second end comprising an expansion tip.

5. The locking screwdriver as recited in claim 4, wherein the expansion tip is configured to deflect the expansion segments radially outward when the expansion tip is translated into the distal end in a direction towards the proximal end.

6. The locking screwdriver as recited in claim 5, wherein the expansion tip comprises a mandrel tip.

7. The locking screwdriver as recited in claim 4, wherein the expansion tip is configured to deflect the expansion segments radially outward when the expansion tip is translated into the distal end in a direction away the proximal end.

8. The locking screwdriver as recited in claim 7, wherein the expansion tip comprises a conical tip.

9. The locking screwdriver as recited in claim 4, wherein the expansion member further comprises a block disposed in the cannulated section of the shaft, the block coupled to the actuator and the first end of the expansion rod coupled to the block.

10. The locking screwdriver as recited in claim 9, wherein the block comprises a threaded bore, the threaded bore configured to receive complimentary threads defined on the first end of the expansion rod.

11. The locking screwdriver as recited in claim 9, wherein the block has a pin bore defined therethrough in a direction offset from the longitudinal direction, the pin bore configured to receive a pin therein, the pin configured to couple the block to the actuator, and
wherein the actuator comprises a knob having a threaded bore extending therethrough and an annular groove extending radially into the threaded bore, the threaded bore configured to rotatably engage complimentary threads defined on an outer surface of the shaft, and the annular groove configured to retain the pin during translation of the expansion member.

12. A locking screwdriver comprising:
a shaft extending in a longitudinal direction between a proximal end having a handle disposed thereon and a distal end, a longitudinal channel extending into the shaft from the distal end, the channel defining a bottom surface that is sloped at the distal end of the shaft, the shaft defining retaining members along opposing sides of the channel;
a sliding member disposed in the channel and retained within the channel by the retaining members, the sliding member translatable within the channel; and
an actuator operatively coupled to the shaft and to a second end of the sliding member, the actuator configured to translate the sliding member within the channel,
wherein the distal end of the shaft and a first end opposite the second end of the sliding member are configured to be concurrently received in a driving opening of a bone anchor such that when the first end of the sliding member rides along the sloped surface, the first end of the sliding member is displaced radially outward within the driving opening, releasably locking the distal end of the shaft and the first end of the sliding member within the driving opening of the bone anchor.

13. The locking screwdriver as recited in claim 12, wherein the actuator comprises a knob having a threaded bore extending therethrough and a coupling interface configured to receive complimentary coupling members defined on the sliding member, the threaded bore configured to rotatably engage complimentary threads defined on an outer surface of the shaft.

14. The locking screwdriver as recited in claim 13, wherein the coupling interface comprises a pair of annular grooves extending into the knob from opposing ends of the knob, the annular grooves configured to the coupling members.

15. The locking screwdriver as recited in claim 14, wherein the coupling members comprise a pair of tabs extending radially outward from the sliding member, each of the tabs configured to be received in a respective one of the annular grooves.

16. The locking screwdriver as recited in claim 12, wherein the retaining members of the shaft comprise a pair of arced protrusions extending inwardly from opposing upper edges of the channel.

17. The locking screwdriver as recited in claim 16, wherein the sliding member comprises a narrowed section, the narrowed section configured to be disposed between the arced protrusions.

18. The locking screwdriver as recited in claim 16, wherein the sliding member further comprises longitudinal wings configured to be received within the arced protrusions, engagement between the wings and the arced protrusions retaining the sliding member within the channel.

19. The locking screwdriver as recited in claim 12, wherein the sloped surface is flat between the distal end of the shaft and a transition into the bottom surface of the channel.

20. The locking screwdriver as recited in claim 12, wherein the sloped surface is curved between the distal end of the shaft and a transition into the bottom surface of the channel.

21. The locking screwdriver as recited in claim 12, wherein the second end of the sliding member defines a tip section with a sloped tip surface.
